(19) United States
(12) Patent Application Publication
(10) Pub. No.: US 2011/0269416 A1
(43) Pub. Date: Nov. 3, 2011

(54) TRANSMITTER

(75) Inventors: Ryo Kadoi, Fujisawa (JP); Akio Yamamoto, Hiratsuka (JP)

(73) Assignee: RENESAS ELECTRONICS CORPORATION

(21) Appl. No.: 13/095,638

(22) Filed: Apr. 27, 2011

(30) Foreign Application Priority Data
Apr. 28, 2010 (JP) 2010-102981

(51) Int. Cl. H04W 52/04; H04W 52/52

(52) U.S. Cl. 455/127.2; 455/127.1

(57) ABSTRACT

The present invention provides a transmitter which performs matching between parts, corresponding to switching between bands for transmission signals and performs more suitable matching in response to unintended changes in device characteristics inside the parts due to secular changes or the like, and etc. The transmitter includes matching circuits coupled to the input and output sides of each amplifier, and level detectors each of which inputs therein the amplified transmission signal via the matching circuit and detects the level of the transmission signal. When one is selected from a plurality of transmission bands to generate a transmission signal, the transmitter sets the value of impedance corresponding to the transmission band to the corresponding matching circuit and fine-adjusts the set value of impedance, based on the result of detection by the corresponding level detector after the setting of the value of the impedance thereto.

### CROSS-REFERENCE TO RELATED APPLICATIONS

The present application claims priority from Japanese patent application JP 2010-102981 filed on Apr. 28, 2010, the content of which is hereby incorporated by reference into this application.

### BACKGROUND

The present invention relates to a transmitter which transmits a signal through an antenna, and in particular to a technology effectively applied to a transmitter which performs transmission by switching among a plurality of bands.

A portable phone terminal separates a used frequency into a plurality of bands and uses properly the separated frequency bands (hereinafter also called “bands”) according to a use area and a portable phone carrier. The portable phone terminal using the plural bands needs a portable phone module, an IC chip and the like corresponding to the plural bands. When a module or the like corresponding to a plurality of bands is fabricated, attempting to provide parts or the like necessary for every band results in increases in the number of parts and the area of an IC. It is therefore necessary to share parts or the like between different bands. For example, there is a need to allow a power amplifier for transmission to be used in common and allow one power amplifier to handle a plurality of bands. The number of bands handled by a portable phone terminal is considered to increase due to an increase in recent communication systems and changes in frequency usage conditions for each area. There is therefore considered a more growing need for sharing of the parts or the like.

On the other hand, there has recently been a demand for a portable phone terminal to have low power consumption and a high-efficient operation. In order to achieve these, there is a need to carry out efficient transmission having suppressed signal needless reflection upon connections between parts such as IC, chip parts, etc. for the portable phone terminal, for example. For this reason, accurate impedance matching between parts coupled is needed.

Since, however, the optimum matching conditions between parts differ depending on the frequency to be handled where the parts are shared between a plurality of bands, it becomes necessary to adjust impedance matching for every band.

A related art that performs matching between parts according to a band to be used has been disclosed in each of patent documents 1 and 2 described later.

A transmitting device described in the patent document 1 stores in a memory in advance, control information for performing matching of a matching circuit comprised of a variable capacitor, which is provided between an antenna and a wide-band amplifier circuit, takes out the control information corresponding to a channel (band) for a transmission signal from the memory, and varies the capacitance value of the variable capacitor, based on the control information, thereby carrying out matching.

A power amplification load control system described in the patent document 2 reads a control value corresponding to a command for setting an operation channel for a signal to be transmitted, and output power from a memory and performs the matching of a variable impedance network provided at the output of a power amplifier, based on the control value.

### Patent Document 1

Japanese Unexamined Patent Publication No. 2007-60455

### Patent Document 2

Japanese Unexamined Patent Publication No. 2001-68942

### SUMMARY

According to the transmitting devices described in the patent documents 1 and 2, the impedance of the matching circuit is adjusted based on the control information for each channel stored in the memory in advance to thereby make it possible to perform matching every band to be used. In the transmitting device or the like, however, when unintended changes in the values of devices inside parts due to secular changes in parts or the like, and the like have occurred, the transmitting device itself is not able to perform the optimum matching in response to the changes in the values of the devices or the like.

An object of the present invention is to provide a transmitter capable of performing matching between parts, corresponding to switching between bands for transmission signals and performing more appropriate matching in response to unintended changes in device characteristics inside the parts due to secular changes or the like, and the like.

The above and other objects and novel features of the present invention will be apparent from the description of the specification and the accompanying drawings.

A summary of a typical one of the inventive aspects of the invention disclosed in this application will be briefly described as follows:

A transmitter that amplifiers a signal and transmits the amplified signal via an antenna includes matching circuits coupled to the input and output sides of each amplifier which amplifies and outputs a generated transmission signal, and level detectors each of which inputs therein the amplified transmission signal via the matching circuit and detects the level of the transmission signal. When one is selected from a plurality of transmission bands to generate a transmission signal, the transmitter sets the value of impedance corresponding to the transmission band to the corresponding matching circuit and fine-adjusts the set value of impedance, based on the result of detection by the corresponding level detector after the setting of the value of the impedance thereto.

Advantageous effects obtained by the typical one of the inventive aspects of the invention disclosed in the present application will be briefly explained as follows:

A transmitter performs matching between parts, corresponding to switching between bands for transmission signals and performs more appropriate matching in response to unintended changes in device characteristics inside the parts due to secular changes or the like, and the like.

### BRIEF DESCRIPTION OF THE DRAWINGS

FIG. 1 is a block diagram showing one example of a transceiver according to a first embodiment;

FIG. 2 is an explanatory diagram illustrating the relationship between frequency bands at bands V and VIII of WCDMA;

FIG. 3 is a circuit diagram depicting one example of a basic circuit configuration of a matching circuit;

FIG. 4 is a circuit diagram showing one example of a matching circuit of which the value of impedance is variable;

FIG. 5 is a circuit diagram showing another example of a matching circuit of which the value of impedance is variable;

FIG. 6 is a circuit diagram illustrating a further example of a matching circuit of which the value of impedance is variable;

FIG. 7 is a circuit diagram depicting one example of a circuit configuration of each of level detectors 110 and 111;

FIG. 8 is an explanatory diagram showing one example of impedance information 3000 according to the first embodiment;

FIG. 9 is a flow diagram illustrating one example of impedance matching by a matching circuit controller 113;

FIG. 10 is a block diagram depicting one example of a transceiver according to a second embodiment;

FIG. 11 is an explanatory diagram showing one example of an installation location of a sensor unit 205;

FIG. 12 is an explanatory diagram illustrating one example of impedance information 3010 according to the second embodiment;

FIG. 13 is a block diagram depicting one example of a transceiver according to a third embodiment; and

FIG. 14 is an explanatory diagram showing one example of gain distribution information.

### DETAILED DESCRIPTION

### 1. Summary of the Embodiments

A summary of typical embodiments of the invention disclosed in the present application will first be explained. Reference numerals of the accompanying drawings referred to with parentheses in the description of the summary of the typical embodiments only illustrate elements included in the concept of components to which the reference numerals are given.

[1] (Transmitter that Fine-Adjusts the Value of Impedance According to the Signal Level)

A transmitter (1, 2, 3) according to a typical embodiment of the present invention is a transmitter which amplifiers a signal and transmits the same through an antenna (101). The transmitter has a signal generating unit (12, 32) which selects one from a plurality of transmission bands and generates a transmission signal corresponding to the selected transmission band, a signal converting unit (11, 31) which converts a frequency of the generated transmission signal and amplifies and outputs the so-processed signal, and an amplifying unit (106, 107, 301, 302) which is coupled to an output terminal of the signal converting unit and amplifies and outputs the signal. The transmitter has a first matching circuit (104, 105) disposed between the output terminal of the signal converting unit and an input terminal of the amplifying unit, and a level detecting unit (110, 111) which is coupled to an output terminal of the amplifying unit and which detects a level of the amplified transmission signal and outputs a result of detection thereof. Further, the transmitter has a second matching circuit (108, 109) disposed between the output terminal of the amplifying unit and an input terminal of the level detecting unit, and a matching circuit control unit (113) which adjusts impedances of the first and second matching circuits. The matching circuit control unit has a first memory unit (114) which holds impedance information for determining the value of the impedance of each of the matching circuits in association with index information corresponding to a transmission band. The signal generating unit outputs a transmission signal for determining the impedance of each of the matching circuits, and information of a transmission band related to the transmission signal. Then, the matching circuit control unit sets a value of impedance to each of the first and second matching circuits, corresponding to the impedance information read from the first memory unit, based on the outputted information of transmission band, and fine-adjusts the set value of impedance, based on the result of detection subsequent to the setting of the value of impedance. According to this, the impedance matching corresponding to the transmission band is performed and the impedance is fine-adjusted corresponding to the level of the amplified transmission signal. Therefore, even when the accuracy of matching deviates due to changes in device characteristics of parts due to secular changes or the like, the impedance matching corresponding to the changes in the device characteristics can be performed. Since the value of impedance is fine-adjusted based on the impedance information after the setting of the impedance value, the impedance matching can be performed in a short period of time as compared with the case in which the impedance matching is performed by simply performing an adjustment corresponding to a signal level without performing the setting based on the impedance information.

[2] (Fine Adjustment)

In the transmitter described in the paragraph 1, the matching circuit control unit varies the value of impedance within a predetermined range with the value of impedance set to each of the matching circuits as a reference, and adjusts the value of the impedance of the matching circuit in such a manner that the signal level becomes maximum. According to it, it is possible to set the value of impedance that achieves more efficient transmission than the value of impedance set based on the impedance information.

[3] (Details of Fine Adjustment)

In the transmitter described in the paragraph 2, the matching circuit control unit further has a rewritable second memory unit (118, 207). The matching circuit control unit assumes the value of impedance set in accordance with the impedance information read from the first memory unit as a center value in the predetermined range and varies the value of impedance for each predetermined adjustable width with respect to the center value to set the corresponding impedance to each of the matching circuits. The matching circuit control unit stores the result of detection at the set impedance in the second memory unit in association with the value of the impedance and sets the value of impedance that brings about the maximum signal level within the stored result of detection as a value of impedance for each of the first and second matching circuits. According to it, it is possible to easily perform impedance matching that realizes more efficient transmission.

[4] (Level Detection Circuit)

In the transmitter described in the paragraph 2 or 3, the level detection circuit has a detection unit (4100) which outputs a detection signal in which the level of the amplified transmission signal is converted, and a generation unit (4101) which smoothes the detection signal and outputs a level of the smoothed signal as the result of detection. According to it, the level of the transmission signal can be converted to a dc voltage level and hence the level of the transmission signal can be easily recognized.

[5] (Configuration of Matching Circuit)

In the transmitter described in any of the paragraphs 2 through 4, each of the first and second matching circuits has a capacitor (2015 to 2018) and an inductor (2010 to 2013) and is capable of changing the value of one of them or both values.

[6](Temperature Sensor)

The transmitter described in any of the paragraphs 1 to 5 further includes a temperature sensor unit (201, 202) for measuring the temperature of the amplifying unit. The index information includes information indicative of a temperature along with the information of the transmission band. The matching circuit control unit acquires the corresponding impedance information from the first memory unit, based on the information of the temperature measured by the temperature sensor unit along with the issued information of the transmission band. According to it, impedance matching having considered not only the transmission band but the temperature of the amplifying unit can be accomplished. Further, operative advantages similar to the paragraph 1 are brought about.

[7] (Gain Adjustment)

The transmitter described in the paragraph 6 further includes a gain adjustment unit (307) which adjusts the respective gains of the signal converting unit and the amplifying unit. The gain adjustment unit has a third memory unit (308) which holds gain distribution information for determining the respective gains of the signal converting unit and the amplifying unit in association with index information containing information of each setting gain indicative of the gain of the amplified signal relative to the generated signal and the information indicative of the temperature. The signal generating unit issues the information of the setting gain when the gains of the signal converting unit and the amplifying unit are determined. The gain adjustment unit reads the corresponding gain distribution information from the third memory unit according to the issued information of the setting gain and the information of the temperature measured by the temperature sensor unit. Then, the gain adjustment unit sets gains corresponding to the gain distribution information to the signal converting unit and the amplifying unit respectively. According to it, it is possible to perform the gain distribution corresponding to a variation in power efficiency of the amplifying unit due to a change in the temperature of the amplifying unit. Further, operative advantages similar to the paragraph 6 are brought about.

[8] (Gain Distribution)

In the transmitter described in the paragraph 7, the gain distribution information includes the information (3023) indicative of the gain of the amplifying unit and the information indicative of the gain (3024) of the signal converting unit. The gain (3022) of the amplified signal relative to the generated signal is a value obtained by adding the gain of the amplifying unit and the gain of the signal converting unit. The information indicative of the gain of the amplifying unit is set in such a manner that the gain of the amplifying unit becomes small according to a rise in temperature. According to it, when the power efficiency of the amplifying unit is reduced with the rise in temperature, an operation good in power efficiency is made possible for the entire transmitter while the gain of the transmission signal as for the entire transmitter is being maintained.

[9] (Independent Paragraph of Gain Adjustment)

A transmitter (3) according to another embodiment of the present invention is a transmitter which amplifiers a signal and transmits the same through an antenna (101). The transmitter has a signal generating unit (32) which selects one from a plurality of transmission bands and generates a transmission signal corresponding to the selected transmission band, a signal converting unit (31) which converts a frequency of the generated transmission signal and amplifies and outputs the so-processed signal, and an amplifying unit (301, 302) which is coupled to an output terminal of the signal converting unit and amplifies and outputs the signal. The transmitter has a gain adjustment unit (307) which adjusts the respective gains of the signal converting unit and the amplifying unit, and a temperature sensor unit (201, 202) for measuring the temperature of the amplifying unit. The gain adjustment unit has a memory unit (308) which holds gain distribution information for determining the respective gains of the signal converting unit and the amplifying unit in association with index information containing information of each setting gain indicative of the gain of the amplified signal relative to the generated signal and the information indicative of a temperature. The signal generating unit issues the information of the setting gain when the gains of the signal converting unit and the amplifying unit are determined. The gain adjustment unit reads the corresponding gain distribution information from the memory unit according to the issued information of the setting gain and the information of the temperature measured by the temperature sensor unit and sets gains corresponding to the gain distribution information to the signal converting unit and the amplifying unit respectively. According to it, it is possible to perform the gain distribution corresponding to power efficiency of the amplifying unit with a change in the temperature of the amplifying unit.

### 2. Details of the Embodiments

Embodiments will be explained in more detail.

### First Embodiment

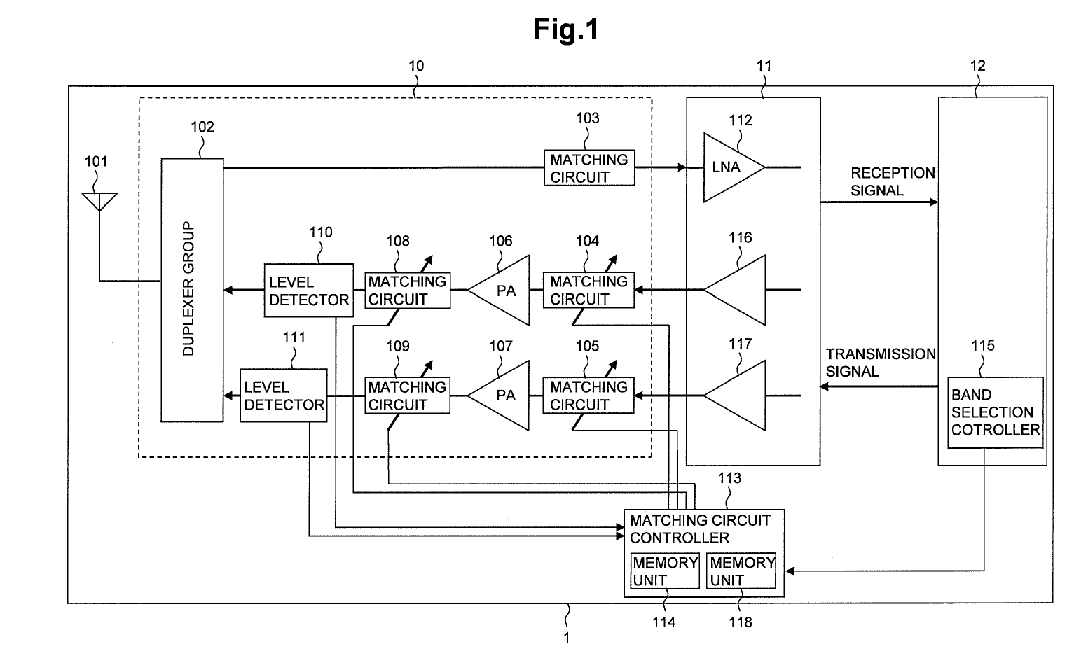

FIG. 1 shows, as one embodiment of a transmitter according to the present invention, a transmitter-receiver or transceiver adapted to a plurality of bands, which performs the transmission/reception of a signal to and from a portable phone terminal.

The transceiver 1 shown in FIG. 1 has an antenna 101, a front-end circuit 10, an RF (RADIO FREQUENCY) unit 11, a baseband unit 12, and a matching circuit controller 113. FIG. 1 shows only components required for explanation for convenience.

The transceiver 1 applies a signal received by the antenna 101 to the RF unit 11 via the front-end circuit 10 to thereby convert the frequency of the received signal and its level and demodulates the signal received through the baseband unit 12. Further, the transceiver 1 generates a transmission signal corresponding to a transmission band used in communications through the baseband unit 12 and converts the frequency of the generated transmission signal and its level through the RF unit 11. Then, the transceiver 1 amplifies the signal through the front-end circuit 10 and transmits it via the antenna 101. At this time, the transceiver 1 adjusts the internal impedance of the front-end circuit 10 through the matching circuit controller 113.

The internal circuits of the transceiver 1 will be explained in detail.

The baseband unit 12 receives the signal received by the antenna 101 from the RF unit 11 and demodulates the reception signal. Further, the baseband unit 12 selects one from a plurality of transmission bands and modulates transmission information according to the selected transmission band to thereby generate a transmission signal. At this time, the baseband unit 12 generates and outputs information about the transmission band related to the transmission signal through a band selection controller 115 provided thereinside. The baseband unit 12 is of an IC chip for baseband processing, for example.

The RF unit 11 inputs therein the signal received from the antenna 101 via the front-end circuit 10 and converts the input reception signal to the frequency and amplitude processable by the subsequent-stage baseband unit 12, followed by being outputted therefrom. Further, the RF unit 11 converts the transmission signal generated by the baseband unit 12 to the frequency and amplitude that enables transmission by the antenna 101 and processing by the front-end circuit 10, followed by conduction of its output. The RF unit 11 has an LNA (Low Noise Amplifier) 112 which amplifies the reception signal, and output amplifiers 116 and 117 which amplify the transmission signal. Further, the RF unit 11 has a mixer, a filter and the like not shown in addition to the amplifiers 112, 116 and 117. When the RF unit 11 amplifies and outputs the transmission signal, it selects either the output amplifier 116 or the output amplifier 117 according to the transmission band of the transmission signal to output the transmission signal. For example, when the transmission signal having the frequency corresponding to the frequency band of a low-frequency power amplifier 106 to be described later is outputted, the signal from the output amplifier 116 is outputted. On the other hand, when the transmission signal having a frequency corresponding to a frequency band of a high-frequency power amplifier 107 to be described later is outputted, the signal from the output amplifier 117 is outputted.

The front-end circuit 10 has a duplexer group 102 having a plurality of duplexers for distributing transmission and reception signals, corresponding to the number of bands for the reception signal and the number of bands for the transmission signal respectively. The front-end circuit 10 causes the reception signal received by the antenna 101 to pass through the duplexer corresponding to the band for the reception signal to thereby determine a transmission path and applies the reception signal to the RF unit 11. The front-end circuit 10 amplifies the transmission signal outputted from the RF unit 11 by the power amplifier 106 or 107 to be described later and outputs it from the antenna 101 via the duplexer group 102.

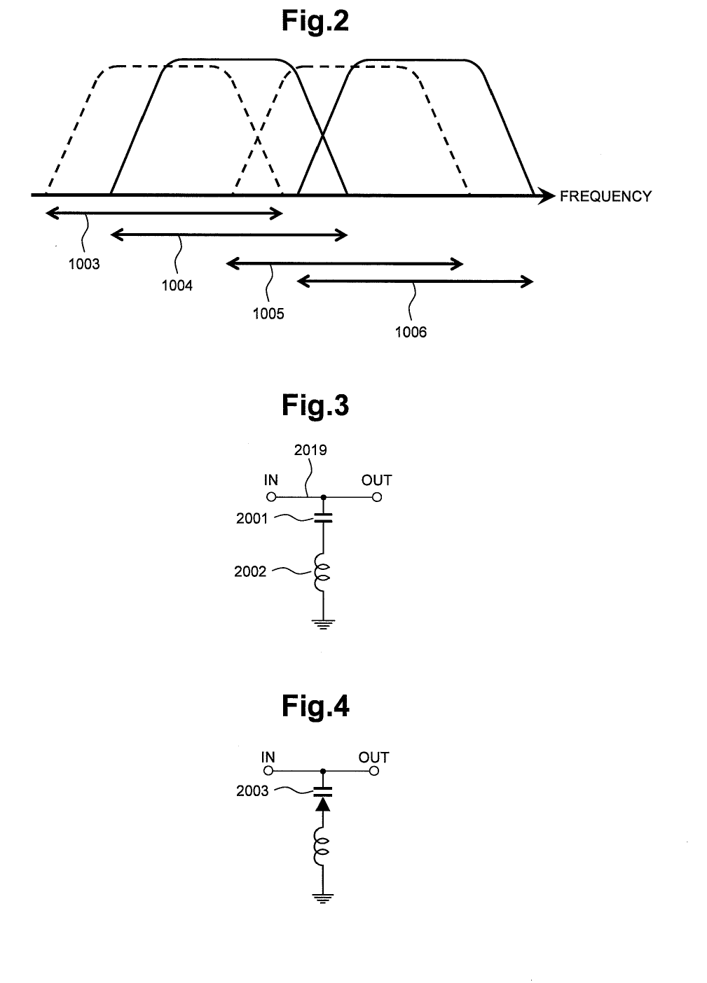

The front-end circuit 10 has the power amplifiers 106 and 107 each of which is coupled to an output terminal of the RF unit 11 and amplifies and outputs the corresponding signal. The required number of power amplifiers is determined according to the number of bands used in the transmission. Since the frequency band at which the amplifying operation of each power amplifier is enabled, is wider than the bandwidth of one transmission band, the number of power amplifiers can be made less than the number of bands for the transmission signal. This will be specifically explained with FIG. 2 as an example.

FIG. 2 is a diagram showing the relationship between the frequency bands at the bands V and VIII of WCDMA.

In FIG. 2, the band indicated by a broken line indicates a band V, the band indicated by a solid line indicates a band VIII. In FIG. 2, a range designated at reference numeral 1003 is a transmission band (824 through 849 MHz) at the band V. A range designated at reference numeral 1004 is a transmission band (880 through 915 MHz) at the band VIII. Further, a range designated at reference numeral 1005 is a reception band (869 through 894 MHz) at the band V, and a range designated at reference numeral 1006 is a reception band (925 through 960 MHz) at the band VIII. Since the transmission band 1003 of the band V and the transmission band 1004 of the band VIII are frequency bands close to each other as shown in FIG. 2, it is possible to share the power amplifier to be used. The front-end circuit 10 employed in the present embodiment is equipped with two power amplifiers of the low-frequency power amplifier 106 which handles signals (bands V, VI, VIII and the like at WCDMA) of less than 1700 MHz, and the high-frequency power 107 which handles signals (bands I, II, III, IV, VII, IX and the like) of greater than or equal to 1700 MHz.

The front-end circuit 10 further has matching circuits 104 and 105 for efficiently performing the transmission of the transmission signal between the RF unit 11 and the low-frequency power amplifiers 106 and 107, and matching circuits 108 and 109 for efficiently performing the transmission of the transmission signal between the low-frequency power amplifiers 106 and 107 and the duplexer group 102. The front-end circuit 10 includes a matching circuit 103 for efficiently performing the transmission of the reception signal between the duplexer group 102 and the RF unit 11 in a manner similar to the transmission signal.

One example of the matching circuit is shown in each of FIGS. 3 through 6.

FIG. 3 is a diagram showing a basic circuit configuration of the matching circuit.

The matching circuit shown in FIG. 3 is a matching circuit having a basic circuit configuration, in which a capacitor 2001 and a coil 2002 are coupled in series between a signal line 2019 for coupling an input terminal and an output terminal to each other and ground.

The matching circuit shown in FIG. 4 is one example of a matching circuit of which the value of impedance is adjustable. A capacitance value is varied according to the magnitude of a bias voltage applied to an input terminal or an output terminal, using a varactor diode 2003 instead of the capacitor 2001 to thereby vary the frequency at which optimum matching is taken or accomplished.

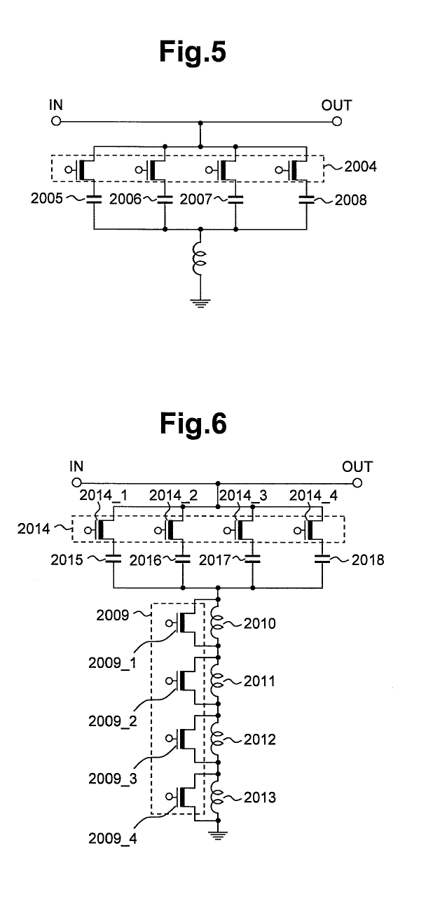

The matching circuit shown in FIG. 5 is another example of a matching circuit of which the value of impedance is adjustable. This is of a matching circuit in which a plurality of sets in which capacitors and MOS transistors are coupled in series, are prepared and coupled in parallel to each other. The MOS switches of a switch group 2004 comprised of the MOS transistors are turned on and off to select the capacitor to be used, thereby varying the frequency at which matching is taken.

The matching circuit shown in FIG. 6 is a further example of a matching circuit of which the value of impedance is adjustable. This is of a matching circuit capable of varying not only the value of each capacitor but the value of each coil. In the matching circuit, MOS switches of a switch group 2009 are turned on and off to select a coil to be used, thereby varying the frequency at which matching is taken.

The transceiver 1 according to the present embodiment is not limited in particular, but each of the matching circuits 104, 105, 108 and 109 corresponds to the matching circuit having the circuit configuration shown in FIG. 6. The impedance of each of the matching circuits 104, 105, 108 and 109 is controlled by the matching circuit controller 113. The details of its control method will be explained later.

The front-end circuit 10 further includes level detectors 110 and 111 which respectively detect the levels of the output signals of the power amplifiers 106 and 107. The level detectors 110 and 111 detect the levels of the output signals of the power amplifiers 106 and 107 and apply the results of detection thereby to the matching circuit controller 113.

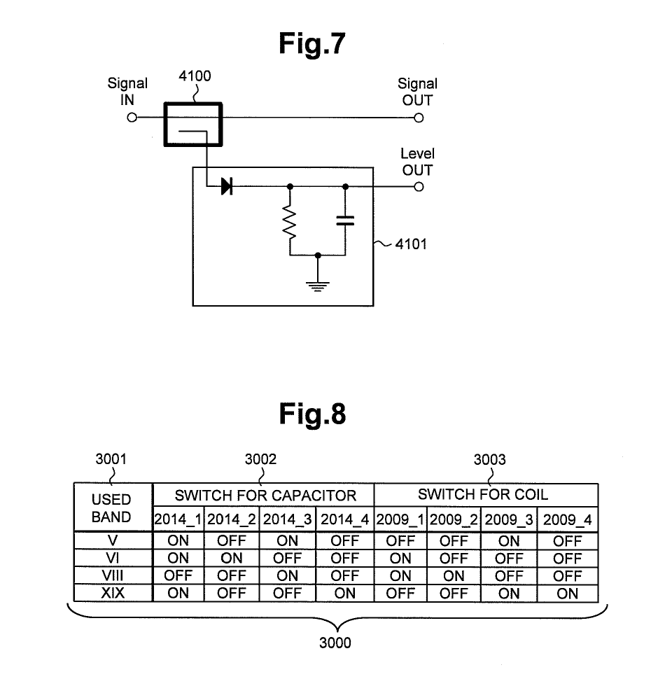

FIG. 7 is a diagram showing one example of a circuit configuration of each of the level detectors 110 and 111.

In FIG. 7, a coupler 4100 for distributing each signal takes out or extracts a part of the output signal of the power amplifier. Then, a signal generation unit 4101 rectifies the part thereof through a signal detecting diode and outputs a dc voltage obtained by its smoothing as the result of detection indicative of a signal level. According to this, since the output signal is taken out by the coupler 4100, the signal level can be detected without exerting a large influence on the original signal. Thus, the detected result of signal level can be outputted as a dc voltage.

A concrete control method of impedance matching by the matching circuit controller 113 will next be described.

The matching circuit controller 113 adjusts the values of the impedances of the matching circuits 104, 105, 108 and 109, based on the information of the transmission band outputted from the band selection controller 115 and the results of detection by the level detectors 110 and 111 to thereby carry out the impedance matching of the transceiver 1.

When the values of the impedances of the matching circuits 104, 105, 108 and 109 are determined, the matching circuit controller 113 first reads impedance information for determining the value of the impedance of each of the matching circuits, which has been stored in advance in a memory unit 114 included in the matching circuit controller 113, based on the information of the transmission band. The impedance information is information indicating on/off states of the respective switches of the switch groups 2014 and 2009, corresponding to the bands used in signal transmission. As to the impedance information, information on the setting of the matching circuit most suitable for each used band is determined based on the result of measurement of a test sample, which has been done in advance, its simulation result, etc., and the determined information is stored in the memory unit 114.

FIG. 8 is one example illustrative of the impedance information of the matching circuits 104, 105, 108 and 109. As shown in FIG. 8, impedance information 3000 is stored in the memory unit 114 as information in which control information 3002 of the switches for the capacitors and control information 3003 of the switches for the coils are associated with information of the used band 3001.

When the information of the transmission band outputted from the baseband unit 12 corresponds to one indicative of “band V”, for example, the transmission signal is outputted from the output amplifier 116 of the RF unit 11 and inputted to the low-frequency power amplifier 106. For this reason, the matching circuit controller 113 adjusts the impedances of the matching circuits 104 and 108. At this time, the matching circuit controller 113 acquires the impedance information of the matching circuit 105 corresponding to the “band V” from the memory unit 114 and determines the states of the switch groups 2014 and 2009 of the matching circuit 105, based on the acquired information. That is, the matching circuit controller 113 sets the capacitor switch 2014_1 to turn on, the capacitor switch 2014_2 to turn off, the capacitor switch 2014_3 to turn on, and the capacitor switch 2014_4 to turn off, respectively. Further, the matching circuit controller 113 sets the coil switch 2009_1 to turn off, the coil switch 2009_2 to turn off, the coil switch 2009_3 to turn on, and the coil switch 2009_4 to turn off, respectively.

Next, the matching circuit controller 113 fine-adjusts the values of the impedances of the matching circuits 104, 105, 108 and 109 all set based on the impedance information, according to the results of detection by the level detectors 110 and 111. Specifically, the matching circuit controller 113 varies the values of the impedances of the matching circuits 104, 105, 108 and 109 within a predetermined range, determines the impedance value at which the level of the output signal of the power amplifier 106 or 107 is the largest, of the results of detection relative to the varied impedance values, as the impedance value at which matching is most accomplished, and sets the value to the matching circuits. When, for example, the capacitance values of such capacitors 2015 through 2018 as shown in FIG. 6 are 4 pF, 2 pF, 1 pF and 0.5 pF respectively and the band to be used in transmission is given as the “band V”, the values of the capacitors of the matching circuits are set to 5 pF as understood from FIG. 8. Then, the value of each individual capacitor is varied within the range in which a matching frequency is not greatly varied due to the value of 5 pF. The values of the capacitors are varied to, for example, a value obtained by adding the value 0.5 pF of the capacitor 2018, which is smallest in capacitance value among the capacitors 2015 through 2018, to the capacitance value 5 pF or subtracting it from the capacitance value 5 pF, i.e., 5.5 pF or 4.5 pF, whereby he results of detection at the values of the respective impedances are obtained. The so-obtained results of detection are stored associated with the values of the impedances, in a memory unit 118 having a rewritable memory region, which is provided in the matching circuit controller 113. Then, the matching circuit controller 113 selects the impedance value largest in the signal level out of the results of detection stored in the memory unit 118. When the signal level is the largest where the value of the capacitor is 5.5 pF among 4.5 pF, 5.0 pF and 5.5 pF, for example, the matching circuit controller 113 sets the switch 2014_4 to an on state to thereby adjust the capacitance value from the capacitor value 5.0 pF set based on the impedance information to 5.5 pF.

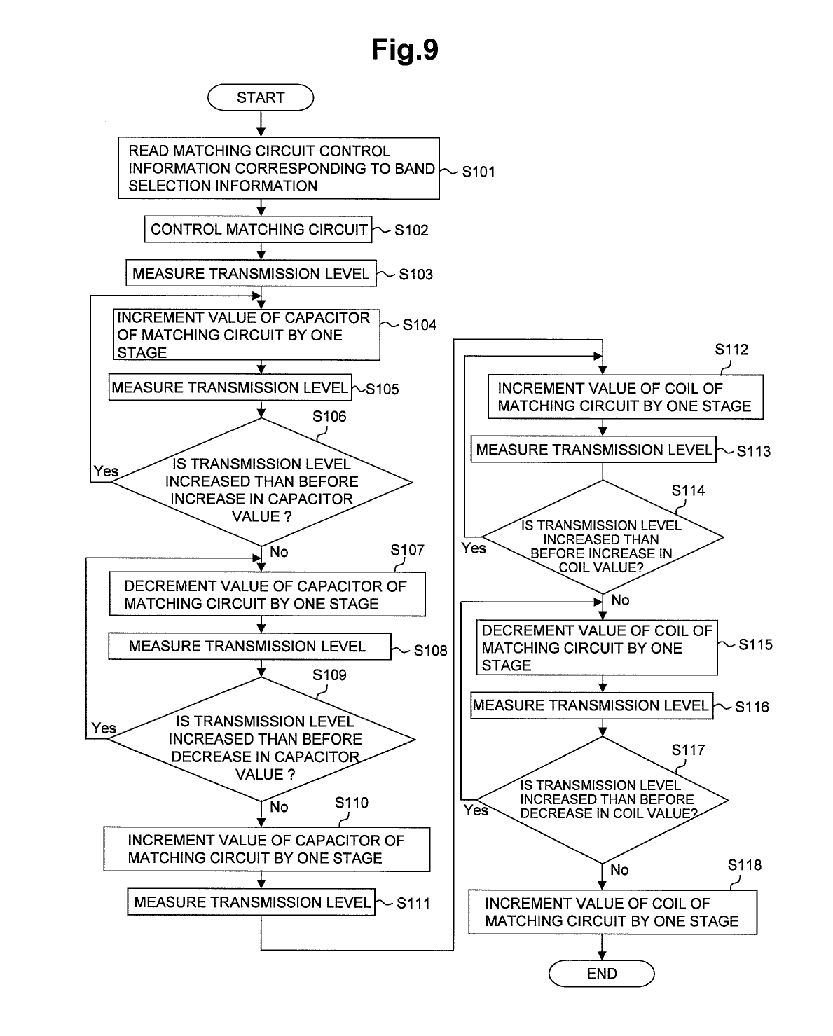

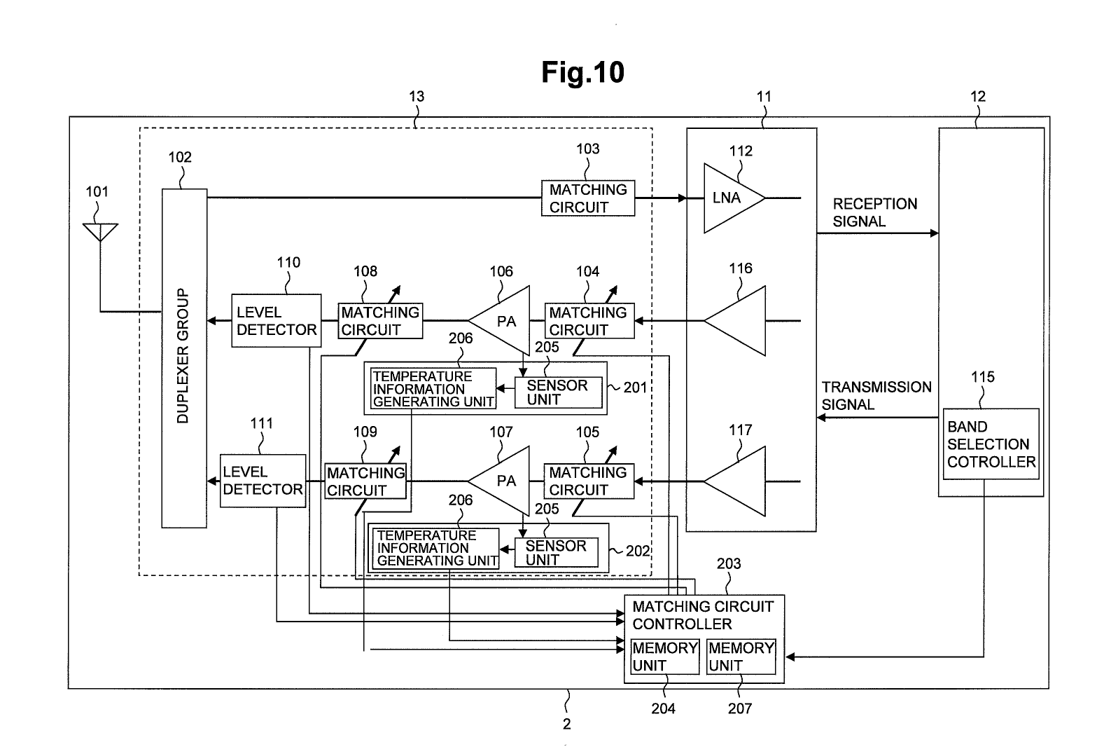

A concrete method for adjusting the impedance by the matching circuit controller 113 will be explained in detail using FIG. 9.

FIG. 9 is one example of a flowchart for explaining a method for adjusting the impedance by the matching circuit controller 113.

When the baseband unit 12 transmits a signal by switching between bands, for example, the baseband unit 12 outputs the generated signal and outputs the information of the transmission band from the band selection controller 115. Then, the matching circuit controller 113 reads the corresponding impedance information from the memory unit 114, based on the output information of the transmission band (S101). The matching circuit controller 113 sets the values of the impedances of the matching circuits 104 and 108 or the matching circuits 105 and 109 by the above method, based on the impedance information (S102). Then, the matching circuit controller 113 acquires the result of detection of the level of the output signal outputted from power amplifier 106 or 107 from the level detector 110 or 111 and stores the same in the memory unit 118 in association with the corresponding set impedance value (S103). Then, the matching circuit controller 113 performs control for incrementing the value of the capacitor of the corresponding matching circuit by one stage (S104). When the value of each capacitor set at Step S102 is 5 pF in the matching circuit of FIG. 6, for example, the capacitor 2018 having 0.5 pF taken as the minimum adjustment unit is placed in connection by its corresponding switch to thereby bring its capacitance value to 5.5 pF. Thereafter, the level detector 110 or 111 measures the level of the output signal of the power amplifier 106 or 107 and outputs the result of its measurement or detection (S105). The matching circuit controller 113 acquires the result of detection outputted at Step S105, stores the same in the memory unit 118 and determines whether the level of the output signal becomes large as compared with before the value of each capacitor is incremented by one stage (S106). When it is determined that the signal level has become large, the matching circuit controller 113 increments the value of each capacitor by a further one stage and thereby makes a decision as to the increase in the signal level in a manner similar to the above (S104 through S106). These processes are performed up to the upper limit value of a range in which the value of each capacitor is fine-adjusted. When this range is set to ±1.5 pF on the basis of the value (5.0 pF) set at Step S102, the process of increasing the value of each capacitor from 5.0 pF to 6.5 pF in units of 0.5 pF indicative of the minimum adjustment width and thereby making a comparison between the magnitudes of the signal levels is repeated.

At Step S106, when the level of the output signal is reduced as compared with before the value of each capacitor is incremented by one stage, the matching circuit controller 113 performs control for decrementing the value of each of the capacitors in the matching circuit by one stage (S107). When the value of the capacitor set at Step S102 is 5 pF in the case of the above example, for instance, the value of the capacitor is set to a value of 4.5 pF reduced by 0.5 pF indicative of the minimum adjustment unit. Thereafter, the level detector 110 or 111 measures the level of the output signal in a manner similar to Step S105 and outputs the result of its measurement or detection (S108). The matching circuit controller 113 having acquired the result of detection outputted at Step S108 determines whether the level of the output signal has become large as compared withy before the value of the capacitor is decremented by one stage (Step S109). When it is determined that the signal level has been set large, the matching circuit controller 113 decrements the value of the capacitor by a further ore stage and makes a decision as to an increase in the signal level in a manner similar to the above (Steps S107 through S109). These processes are performed within a range in which the value of each capacitor is fine-adjusted, in a manner similar to Steps S104 through 106. In the case of the above example, for instance, the process of setting the value of each capacitor smaller stepwise from 5.0 pF to 3.5 pF in units of 0.5 pF indicative of the minimum adjustment width and making a comparison between the magnitudes of the signal levels referred to above is repeated. On the other hand, when the level of the output signal becomes small as compared with before the value of each capacitor is decremented by one stage at Step 109, the matching circuit controller 113 performs control for incrementing the value of each of the capacitors in the matching circuit by one stage (S110) and acquires the result of detection again (S111). In the case of the above example, for instance, when the value of the capacitor is decremented from 5.0 pF in 0.5 pF units and reaches 3.5 pF, the value of the capacitor is set to 4.0 pF incremented by one stage from 3.5 pF where the signal level becomes smaller than 4.0 pF preceding 3.5 pF by one stage, whereby a signal level at 4.0 pF is measured. Owing to these series of control, the value of the corresponding capacitor at which the level of the output signal becomes larger, i.e., the value of the capacitor at which matching is more accomplished, can be searched and set.

The matching circuit controller 113 starts to adjust the value of each coil after the result of detection has been acquired at Step S111. The adjustment to the coil value is carried out in a procedure similar to Steps (S104 through S110) of the above method of adjusting the capacitor value. That is, the matching circuit controller 113 first increments the value of each coil in the matching circuit stepwise, acquires the result of detection of the level of the output signal, and determines whether the level of the output signal has become large as compared with before the coil value is incremented by one stage (S112 through S114). Thereafter, the matching circuit controller 113 decrements the value of each coil in the matching circuit stepwise, acquires the result of detection of the level of the output signal, and makes a decision as to whether the level of the output signal has become large as compared with before the value of the coil is decremented by one stage (S115 through S118). Owing to these series of control, the value of the corresponding coil at which the level of the output signal becomes larger, i.e., the value of the coil at which matching is more accomplished, can be searched and set in a manner similar to the case of the capacitor. Incidentally, the above-described impedance fine adjustment may be a method of performing a fine adjustment only once each time the band for transmission is switched, or may be a method of repeatedly performing a fine adjustment on a regular basis after the fine adjustment is carried out once at the band selection. There may be used, for example, a method for adjusting the value of impedance based on the flow shown in FIG. 9 upon band switching and thereafter fine-adjusting the impedance on a regular basis by executing the processes of Steps S104 through S118 of FIG. 9 each time a predetermined interval elapses.

The above series of adjustments to the values of the capacitor and coil enables the value of the impedance at which matching is more accomplished, to be set to each of the matching circuits.

Thus, according to the transceiver 1 according to the first embodiment, the matching circuit controller 113 sets the value of the impedance of the matching circuit, based on the impedance information stored in the memory unit 114 in advance when the band is switched to transmit the signal. For this reason, even where an attempt to use the power amplifier in common is made, the appropriate impedance matching corresponding to the band to be used is enabled. As a result, it will be conducive to reducing the number of parts of a front-end module and RFIC for a portable phone and the areas thereof without sacrificing efficiency at signal transmission.

The matching circuit controller 113 fine-adjusts the impedance set based on the impedance information. Thus, even when the value of the impedance of each matching circuit determined based on the impedance information stored in advance is not the optimum one due to fluctuations in the device characteristics of the capacitor, coil and the like due to device fluctuations, changes with time or the like, and fluctuations in the device characteristics due to variations in temperature, for example, better matching is accomplished as compared with such a matched state. As a result, the efficiency at the signal transmission can be more improved.

Incidentally, it is also possible to accomplish the impedance matching by just an adjustment corresponding to the level of the output signal without the settings based on the impedance information. Fine-adjusting the impedance after the setting based on the impedance information, rather than such an adjustment is a preferable method because the optimum matching condition can be searched and set in a short period of time.

### Second Embodiment

FIG. 10 shows, as another embodiment of the transmitter according to the present invention, a transceiver adapted to a plurality of bands, which performs the transmission/reception of signals to and from a portable phone terminal.

Each of the power amplifiers referred to above tends to become large in the generated amount of heat at its operation and larger in temperature change than other devices. For this reason, the characteristics of the devices lying inside the power amplifier change due to the change in the temperature of the power amplifier, so that the frequency at which matching is taken varies. Thus, the transceiver 2 shown in FIG. 10 is provided with temperature sensors 201 and 202 for measuring the temperatures of power amplifiers 106 and 107, in addition to the components of the transceiver 1 according to the first embodiment, and performs impedance matching, based on information about each transmission band and information about the measured temperatures of power amplifiers.

In FIG. 10, the same reference numerals are respectively attached to components similar to those of the transceiver 1, of the components of the transceiver 2, and their detailed description will therefore be omitted.

The temperature sensors 201 and 202 are circuits for measuring the temperatures of the power amplifiers. They are disposed in the vicinity of the power amplifiers 106 and 107 lying in a front-end circuit 13. Each of the temperature sensors 201 and 202 includes, for example, a sensor unit 205 for measuring a temperature, and a temperature information generating unit 206 for reading a result of measurement by the sensor unit 205 and generating information on the temperature corresponding to the result of measurement. The sensor unit 205 is a temperature sensing diode, for example.

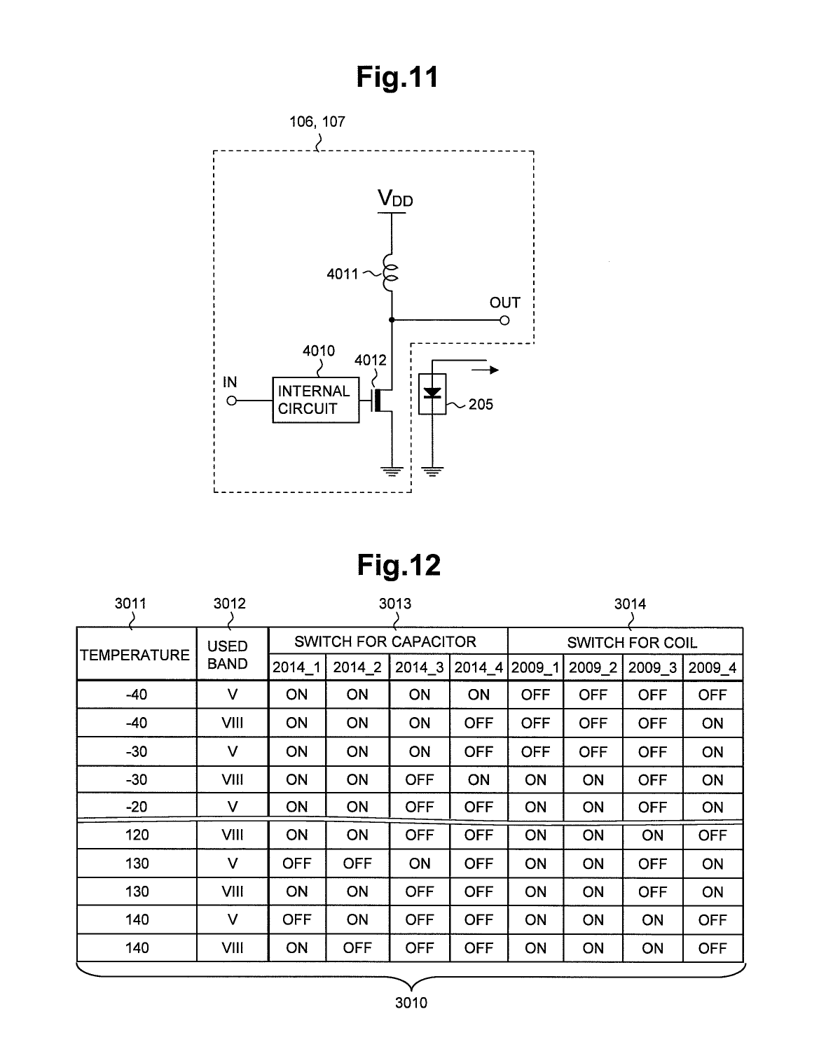

FIG. 11 is a diagram showing one example of an installation location of the sensor unit 205.

In FIG. 11, for convenience of explanation, only a coil 4011 and a transistor 4012 of an output stage are shown in each of the power amplifiers 106 and 107, and other internal circuits are shown therein as an internal circuit 4010 in a simplified form. The temperature sensing diode used as the sensor unit 205 is disposed in proximity to the transistor 4012 being a portion most likely to generate heat at the operation within the power amplifiers 106 and 107.

The temperature information generating unit 206 inputs therein an output voltage varied according to the temperature of the temperature sensing diode 205 and generates and outputs information on the temperature corresponding to the output voltage. The temperature information generating unit 206 is not limited in particular, but measures a temperature ranging from −40° C. to 140° C., for example, in increments of 10° C. and generates information on the corresponding temperature.

A matching circuit controller 203 adjusts the values of impedances of the matching circuits 104, 105, 108 and 109, based on the information on the temperatures of the power amplifiers 106 and 107 measured by the temperature sensors 201 and 202 to thereby perform impedance matching of the transceiver 2. In a manner similar to the matching circuit controller 113, the matching circuit controller 203 has a memory unit 207 which stores therein impedance information for determining the value of impedance of the corresponding matching circuit, and a memory unit 207 having a rewritable memory region, which stores therein the results of detection related to the levels of output signals of the power amplifiers 106 and 107.

The impedance information is information indicating, for each matching circuit, on and off states of each of the switches of the switch groups 2014 and 2009, corresponding to the information on both the band to be used in signal transmission and the temperature. The impedance information is stored in the memory unit 204 in advance as with the transceiver 1.

FIG. 12 is one example of the impedance information 3010 stored in the memory unit 204. As shown in FIG. 12, control information 3013 about switches for capacitors and control information 3014 about switches for coils are stored in the memory unit 204 in association with temperature information 3011 and information on bands 3012 to be used.

A concrete method for controlling impedance matching by the matching circuit controller 203 will next be described.

A flow for the basic control of impedance matching is similar to the flow of control by the matching circuit controller 113 of the transceiver 1. For example, consider where the baseband unit 12 sends a transmission signal related to the “band V”. In this case, the transmission signal is outputted from the output amplifier 116 of the RF unit 11 and inputted to the low-frequency power amplifier 106. For this reason, the matching circuit controller 203 adjusts the impedances of the matching circuit 104 and the matching circuit 108. At this time, the matching circuit controller 203 acquires the information of the transmission band outputted from the band selection controller 115 of the baseband unit 12 and the information of the temperature outputted from the temperature sensor 201. Then, the matching circuit controller 203 acquires the corresponding impedance information from the memory unit 204, based on the transmission band information and the temperature information. When, for example, the transmission band information is indicative of “band V” and the temperature information is of information indicative of “−30° C.”, the matching circuit controller 203 acquires information about switches corresponding to the combinations of these and determines the states of the switch groups 2014 and 2009 of the matching circuit. Namely, the matching circuit controller 203 sets the capacitor switch 2014_1 to turn on, the capacitor switch 2014_2 to turn on, the capacitor switch 2014_3 to turn on, and the capacitor switch 2014_4 to turn off, respectively. Further, the matching circuit controller 203 sets the coil switch 2009_1 to turn off, the coil switch 2009_2 to turn off, the coil switch 2009_3 to turn off, and the coil switch 2009_4 to turn on, respectively.

Next, the matching circuit controller 203 fine-adjusts the values of the impedances of the matching circuits 104 and 108 set based on the transmission band information and the temperature information, according to the result of detection by the level detector 110. A concrete method thereof is similar to the above method by the transceiver 1.

According to the transceiver 2 related to the second embodiment as described above, even if the characteristics of impedance matching of each power amplifier vary due to a change in temperature, the impedance matching corresponding to the change in temperature can be realized. Further, better matching can be accomplished even when device characteristics vary due to changes with time or the like in a manner similar to the transceiver 1 according to the first embodiment. The control on the impedance matching according to the second embodiment may be a method for performing impedance matching only once each time the band for transmission is selected, or may be a method for performing impedance matching on a regular basis after matching is performed once at the time of band switching. Carrying out the impedance matching on a regular basis enables the implementation of the optimum impedance matching even when the temperature varies from the time of the band switching.

### Third Embodiment

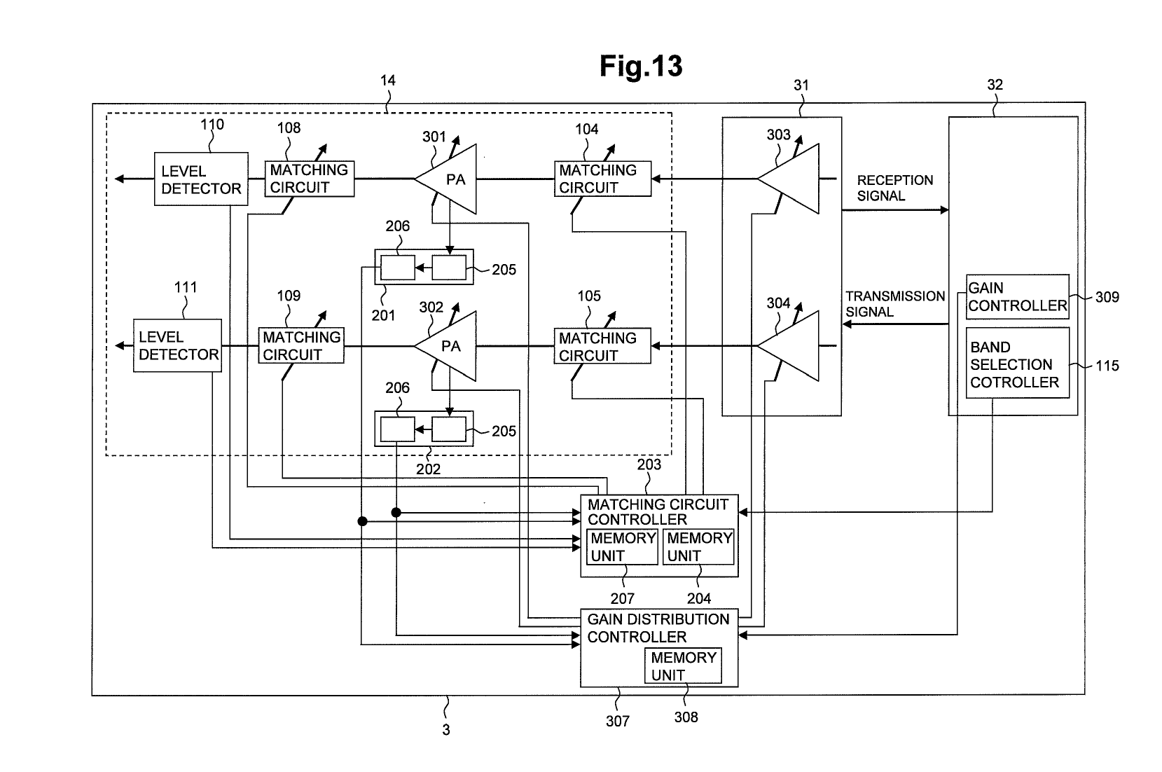

FIG. 13 shows, as a further embodiment of the transmitter according to the present invention, a transceiver adapted to a plurality of bands, which performs the transmission/reception of signals to and from a portable phone terminal.

As described above, each of the power amplifiers referred to above tends to become large in the generated amount of heat at its operation and larger in temperature change than other devices. For this reason, the efficiency of each power amplifier changes due to the change in temperature. That is, even though the gain of the power amplifier is set in such a manner that the efficiency of the power amplifier becomes optimal, a gain setting value at which high efficiency is obtained changes due to a variation in temperature. Thus, the transceiver 3 shown in FIG. 13 has a gain distribution controller 307 which adjusts the gains of power amplifiers 301 and 302 and output amplifiers 303 and 304 of an RF unit 31 according to the measured temperatures, in addition to the components of the transceiver 2 according to the second embodiment.

In FIG. 13, the same reference numerals are respectively attached to components similar to those of the transceiver 2, of components of the transceiver 3, and their detailed description will therefore be omitted. FIG. 13 shows only the components necessary to explain the transceiver 3 according to the present embodiment.

A baseband unit 32 shown in FIG. 13 has a gain controller 309 in addition to the components of the baseband unit 12. The gain controller 309 outputs information (hereinafter called “gain setting value”) on the gain indicative of an amplification factor at the transmission of each generated signal. The gain setting value is information about an amplification factor determined according to a transmission band or the like and is stored in advance in an unillustrated memory device or the like provided inside the baseband unit 32. When each of the gains of the power amplifiers 301 and 302 and the output amplifiers 303 and 304 is set, the gain controller 309 reads and outputs the gain setting value.

The RF unit 31 has the output amplifiers 303 and 304 whose gains are variable, instead of the output amplifiers 116 and 117 of the RF unit 11. In the output amplifiers 303 and 304, the gains thereof are adjusted by control of the gain distribution controller 307. For example, the gains are made variable by adjusting bias voltages lying inside the amplifiers.

The power amplifiers 301 and 302 lying inside a front-end circuit 14 respectively have gain varying functions in addition to the functions of the power amplifiers 106 and 107. Their gain adjustment are controlled by the gain distribution controller 307 in a manner similar to the output amplifiers 303 and 304.

The gain distribution controller 307 has a memory unit 308 that stores therein gain distribution information corresponding to the gain setting values and the temperature information, and adjusts the gains of the power amplifiers 301 and 302 and the output amplifiers 303 and 304, based on the gain distribution information. Specifically, the gain distribution controller 307 acquires the corresponding gain setting value outputted from the gain controller 309 and the temperature information outputted from the temperature sensors 201 and 202. Then, the gain distribution controller 307 reads the gain distribution information corresponding to the acquired information from the memory unit 308 and adjusts the gains of the power amplifiers 301 and 302 and the output amplifiers 303 and 304, based on the read information.

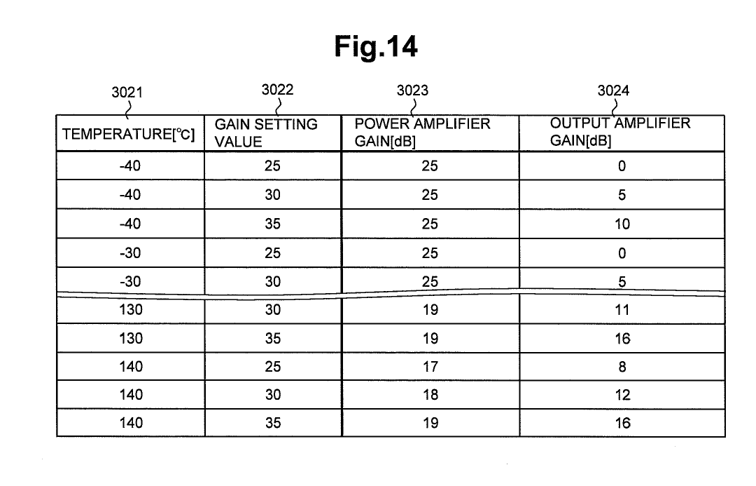

FIG. 14 is a diagram showing one example of the gain distribution information stored in the memory unit 308.

As shown in FIG. 14, the gain distribution information is information about a gain 3023 of each power amplifier and a gain of each output amplifier both corresponding to a temperature 3021 and a gain setting value 3022 for each power amplifier used according to the band for the transmission signal. Since the gain distribution information is of the information for determining the distribution of gain, the sum of the value of the power amplifier gain 3023 and the value of the output amplifier gain 3024 assumes the value of the gain setting value 3022. The gain distribution information is information on the combination of gains distributed in such a manner that total power consumption of the power amplifiers and the output amplifiers becomes the smallest at the temperature of each power amplifier and its set gain. If there is used, for example, a power amplifier in which power efficiency is lowered as the gain increases and reduced as the temperature rises, as shown in FIG. 14, the gain distribution of the power amplifier is set to be smaller with the rise in temperature, and the gain distribution of the output amplifier is set to be larger. Doing so makes it possible to loosen a reduction in the total power efficiency of the power amplifier and the output amplifier with the rise in temperature. These information on the gain distribution are determined based on the result of previously-done measurements of a test sample, the result of simulation thereof, etc., and stored in the memory unit 308 in advance.

Next, a description will be made of a flow for the settings of the gains of the power amplifiers and the output amplifiers and the impedance matching in the transceiver 3.

When the transceiver 3 outputs a transmission signal using the low-frequency power amplifier 301, for example, the baseband unit 32 first outputs the gain setting value. Next, the gain distribution controller 307 acquires the gain setting value and acquires information about the temperature of the power amplifier 301 from the temperature sensor 201. Then, the gain distribution controller 307 reads the corresponding gain distribution information from the memory unit 308, based on the gain setting value and the temperature information, and sets the gains of the power amplifier 301 and the output amplifier 304. When, for example, the temperature of the power amplifier 301 is “130° C.” and the gain setting value outputted from the baseband unit 32 is “30 dB”, the gain distribution controller 307 sets the gain of the power amplifier 301 to “19 dB”, and sets the gain of the output amplifier 303 to “11 dB”.

Thereafter, the baseband unit 32 outputs a transmission signal and information on the transmission band to perform impedance matching. Then, the matching circuit controller 203 acquires the information on the transmission band and acquires the temperature information from the temperature sensor 201, and carries out the impedance matching in accordance with a method similar to the transceiver 2 according to the second embodiment.

The transceiver 3 according to the third embodiment as described above determines, in addition to matching control similar to the transceiver 2, an amplification factor of a transmission signal, based on the total gain of the power amplifiers 301 and 302 and the output amplifiers 303 and 304 provided in their previous stages, and determines the distribution of gain in such a manner that the total power consumption of the amplifiers becomes small, based on the measured temperatures of the power amplifiers having large temperature dependency. Consequently, higher-efficient signal transmission is enabled. Applying to a transceiver of a battery-driven portable terminal, for example, makes it possible to achieve a life extension of a battery.

While the invention made above by the present inventors has been described specifically on the basis of the preferred embodiments, the present invention is not limited to the embodiments referred to above. It is needless to say that various changes can be made thereto within the scope not departing from the gist thereof.

Although there is shown in FIGS. 3 through 6, as one example of the circuit configuration of each of the matching circuits in the transceivers 1 through 3, the configuration in which the capacitor and the coil are branched from th signal line 2019 to the ground, the configuration of the matching circuit is not limited thereto, and any configuration may be used if matching circuits are adopted. For example, the configuration of the matching circuit may take a circuit configuration in which resistive elements are mixed. Although the varactor is used as a variable capacitance in FIG. 4, a capacitance based on MEMS (Micro Electro Mechanical Systems) may be used. Further, although the MOS transistors are used as the switch elements in FIGS. 5 and 6, MEMS switches may be used.

Although there is shown the method for switching the values of the capacitors in the matching circuit using the switch elements in each of the transceivers 1 through 3, no limitation is imposed on it. There may be adopted a method for placing variable capacitance elements such as varactors or the like in parallel instead of the combinations of the capacitors and the switches and causing the matching circuit controllers 113 and 203 to adjust a dc voltage to be applied, for each variable capacitance element.

Although the procedure of determining the value of each coil after the value of each capacitor has been determined is shown at the procedure for control of the impedance matching in FIG. 9, the procedure is not limited to it, but may be used as a procedure for determining the value of each capacitor after determination of the value of each coil. The processes of Step S103 through S118 may be repeatedly performed on several occasions. There may be adopted, for example, a method for determining the value of the capacitor and adjusting the value of the capacitor again after determination of the value of the coil. According to this method, even when the value of the fine-adjusted capacitor deviates from the optimum value due to a change in coil value, the optimum value of the capacitor corresponding to the changed value of coil can be determined. It is therefore possible to perform higher accuracy impedance matching. Incidentally, in the case of a matching circuit including even a resistor in addition to the coil and capacitor as described above, the processes corresponding to Steps S103 through S110 are performed even on the resistor.

At the procedure of the distribution of the gains of the power amplifiers 301 and 302 and the output amplifiers 303 and 304 in FIG. 13, the information on the gain distribution with the optimum efficiency as an index is stored in the memory unit 308. The gain distribution information may be determined using another index, like the case where a gain distribution is determined based on the upper limit value of the gain of the power amplifier or the output amplifier. The distribution of the gain is not limited to the distribution that the power amplifier 3023 is degraded depending on the rise in temperature as shown in FIG. 14.

Although the matching circuit controllers 113 and 203 are respectively configured independently of the baseband units 12 and 32 in the transceivers 1 through 3, they are not limited to this configuration. Circuits equipped with functions similar to the matching circuit controllers 113 and 203 may be configured inside the baseband units 12 and 32 as one IC chip with being built therein.

Although the diode is used as the temperature sensing device in the transceivers 2 and 3, the diode is not limited to it. A device of which the characteristic varies according to the temperature, like a resistor or the like, may be used.

Although the gain distribution controller 307 has performed the gain control of the amplifier, based on the gain setting value and the temperature information in the transceiver 3, no limitation is imposed on such control. The gain distribution controller 307 may carry out gain control using even the transmission band information sent from a band selection controller 115. The matching circuit controller 203 in the transceiver 3 may perform impedance matching, based on the gain distribution information stored in the memory unit 308 of the gain distribution controller 307 in addition to the temperature information and the transmission band information.

Although there is shown the method for adjusting the impedances of the matching circuits 104, 108, 105 and 109 on both input and output sides of the power amplifiers 106, 107, 301 and 302 by the above method in the transceivers 1 through 3, the transceivers 1 through 3 are not limited to this method. Only the matching circuits 108 and 109 on the output side may be adjusted or only the matching circuits 104 and 105 on the input side may be adjusted.

What is claimed is:

1. A transmitter which amplifiers a signal and transmits the same through an antenna, comprising:
a signal generating unit which selects one from a plurality of transmission bands and generates a transmission signal corresponding to the selected transmission band;
a signal converting unit which converts a frequency of the generated transmission signal and amplifies and outputs the so-processed signal;
an amplifying unit which is coupled to an output terminal of the signal converting unit and amplifies and outputs the signal;
a first matching circuit disposed between the output terminal of the signal converting unit and an input terminal of the amplifying unit;
a level detecting unit which is coupled to an output terminal of the amplifying unit and which detects a level of the amplified transmission signal and outputs a result of detection thereof;
a second matching circuit disposed between the output terminal of the amplifying unit and an input terminal of the level detecting unit; and
a matching circuit control unit which adjusts impedances of the first and second matching circuits,
wherein the matching circuit control unit comprises a first memory unit which holds impedance information for determining the value of the impedance of each of the matching circuits in association with index information corresponding to a transmission band,
wherein the signal generating unit outputs a transmission signal for determining the impedance of each of the matching circuits, and information of a transmission band related to the transmission signal, and
wherein the matching circuit control unit sets a value of impedance to each of the first and second matching circuits, corresponding to the impedance information read from the first memory unit, based on the outputted information of transmission band, and fine-adjusts the set value of impedance, based on the result of detection subsequent to the setting of the value of impedance.

2. The transmitter according to claim 1,
wherein the matching circuit control unit varies the value of impedance within a predetermined range with the value of impedance set to each of the matching circuits as a reference, and adjusts the value of the impedance of the matching circuit in such a manner that the signal level becomes maximum.

3. The transmitter according to claim 2,
wherein the matching circuit control unit further comprises a rewritable second memory unit,
wherein the matching circuit control unit assumes the value of impedance set in accordance with the impedance information read from the first memory unit as a center value in the predetermined range and varies the value of impedance for each predetermined adjustable width with respect to the center value to set the corresponding impedance to each of the matching circuits, and
wherein the matching circuit control unit stores the result of detection at the set impedance in the second memory unit in association with the value of the impedance and sets the value of impedance that brings about the maximum signal level within the stored result of detection as a value of impedance for each of the first and second matching circuits.

4. The transmitter according to claim 2,
wherein the level detecting unit comprises:
a detection unit which outputs a detection signal in which the level of the amplified transmission signal is converted; and
a generation unit which smoothes the detection signal and outputs a level of the smoothed signal as the result of detection.

5. The transmitter according to claim 2,
wherein each of the first and second matching circuits comprises a capacitor and an inductor, and
wherein each of the first and second matching circuits is capable of varying the value of at least one of the capacitor and the inductor.

6. The transmitter according to claim 2, further comprising:
a temperature sensor unit which measures the temperature of the amplifying unit,
wherein the index information comprises information indicative of a temperature along with the information of the transmission band, and
wherein the matching circuit control unit acquires the corresponding impedance information from the first memory unit, based on the information of the temperature measured by the temperature sensor unit along with the issued information of the transmission band.

7. The transmitter according to claim 6, further comprising:
a gain adjustment unit which adjusts the respective gains of the signal converting unit and the amplifying unit,
wherein the gain adjustment unit comprises a third memory unit which holds gain distribution information to determine the respective gains of the signal converting unit and the amplifying unit in association with index information containing information of each setting gain indicative of the gain of the amplified signal relative to the generated signal and the information indicative of the temperature,
wherein the signal generating unit issues the information of the setting gain when the gains of the signal converting unit and the amplifying unit are determined, and
wherein the gain adjustment unit reads the corresponding gain distribution information from the third memory unit according to the issued information of the setting gain and the information of the temperature measured by the temperature sensor unit and sets gains corresponding to the gain distribution information to the signal converting unit and the amplifying unit respectively.

8. The transmitter according to claim 7,
wherein the gain distribution information comprises the information indicative of the gain of the amplifying unit and the information indicative of the gain of the signal converting unit,
wherein the gain of the amplified signal relative to the generated signal is a value obtained by adding the gain of the amplifying unit and the gain of the signal converting unit, and
wherein the information indicative of the gain of the amplifying unit is set in such a manner that the gain of the amplifying unit becomes small according to a rise in temperature.

9. A transmitter which amplifiers a signal and transmits the same through an antenna, comprising:
a signal generating unit which selects one from a plurality of transmission bands and generates a transmission signal corresponding to the selected transmission band;
a signal converting unit which converts a frequency of the generated transmission signal and amplifies and outputs the so-processed signal;
an amplifying unit which is coupled to an output terminal of the signal converting unit and amplifies and outputs the signal;
a gain adjustment unit which adjusts the respective gains of the signal converting unit and the amplifying unit; and
a temperature sensor unit for measuring the temperature of the amplifying unit,
wherein the gain adjustment unit comprises a memory unit which holds gain distribution information for determining the respective gains of the signal converting unit and the amplifying unit in association with index information containing information of each setting gain indicative of the gain of the amplified signal relative to the generated signal and the information indicative of a temperature,
wherein the signal generating unit issues the information of the setting gain when the gains of the signal converting unit and the amplifying unit are determined, and
wherein the gain adjustment unit reads the corresponding gain distribution information from the memory unit according to the issued information of the setting gain and the information of the temperature measured by the temperature sensor unit and sets gains corresponding to the gain distribution information to the signal converting unit and the amplifying unit respectively.
